(19) United States
(12) Patent Application Publication
(10) Pub. No.: US 2021/0390506 A1
(43) Pub. Date: Dec. 16, 2021

(54) MATERIAL TRANSPORTATION SUPPORT DEVICE AND MATERIAL TRANSPORTATION METHOD

(71) Applicant: TOYOTA JIDOSHA KABUSHIKI KAISHA, Aichi-ken (JP)

(72) Inventors: Seigo KUZUMAKI, Toyota-shi (JP); Takashi HAYASHI, Toyota-shi (JP)

(21) Appl. No.: 17/343,732

(22) Filed: Jun. 10, 2021

(30) Foreign Application Priority Data
Jun. 11, 2020 (JP) 2020-101864

(51) Int. Cl. G06Q 10/08; G08G 1/127; G06Q 10/10

(52) U.S. Cl. CPC G06Q 10/08355; G06Q 10/1097; G08G 1/127

(57) ABSTRACT

A material transportation support device includes: an acquisition section configured to acquire usage timings for respective materials at a usage location of the materials; and a departure timing setting section configured to set a departure timing from a loading location for each of the materials, based on the usage timings and material information including the loading location of the materials such that the materials arrive at the usage location in sequence starting from a material with an earliest usage timing.

### CROSS-REFERENCE TO RELATED APPLICATION

This application is based on and claims priority under 35 USC 119 from Japanese Patent Application No. 2020-101864 filed on Jun. 11, 2020, the disclosure of which is incorporated by reference herein.

### BACKGROUND

### Technical Field

The present disclosure relates to a material transportation support device and a material transportation method.

### Related Art

Japanese Patent Application Laid-Open (JP-A) No. 2015-193458 discloses a gate system that enables shipping containers to he transferred between third party trailers and transporter vehicles using an overhead crane at a reception gate located outside a yard of a container terminal. In JP-A No. 2015-193458, reservation information is transmitted from a consignor terminal to a server of the gate system in order to ascertain when a container is to be brought in.

In cases in which materials are to be transported to a construction site or the like, temporary holding areas for these materials are limited, and so it is desirable for the materials to be delivered in the sequence in which they are to be used. However, JP-A No. 2015-193458 is a system for transmitting reservation information from consignors, and so even were a transporter vehicle to arrive at its delivery location according to schedule, the transporter vehicle may have to wait in the vicinity of the delivery location depending on the sequence in which materials are to be used. There is accordingly room for improvement regarding this point.

### SUMMARY

The present disclosure provides a material transportation support device and a material transportation method that may enable efficient delivery of materials.

A first aspect of the present disclosure is a material transportation support device including: an acquisition section configured to acquire usage timings for respective materials at a usage location of the materials; and a departure timing setting section configured to set a departure timing from a loading location for each of the materials, based on the usage timings and material information including the loading location of the materials such that the materials arrive at the usage location in sequence starting from a material with an earliest usage timing.

In the material transportation support device of the first aspect, the acquisition section acquires the usage timings of the respective materials at the usage location of the materials. This enables the sequence in which the respective materials are to be used at the usage location, for example a construction site, to be ascertained.

The departure timing setting section sets the departure timing from the loading location for each materials, based on the material information including the material loading location, and the material usage timings acquired by the acquisition section. When this is performed, the departure timing setting section sets the departure timings such that the materials will arrive at the usage location in sequence starting from the material with the earliest usage timing. This enables the materials to be delivered to the usage location in the sequence in which the materials are to be used.

In a second aspect of the present disclosure, in the first aspect, the departure timing setting section may be configured to set the departure timing based on a transportation duration computed from vehicle information including a size of a vehicle for transporting the materials, and based on the material information.

In the material transportation support device of the second aspect, the transportation duration from the loading location to the usage location is computed based on the material information and the vehicle information. This improves the computation accuracy of the transportation duration due to taking into consideration routes that may not be usable due to the size of the transporter vehicle.

A third aspect of the present disclosure, in the first aspect or the second aspect, may further include a loading timing setting section configured to set a loading timing based on the departure timing set by the departure timing setting section.

In the material transportation support device of the third aspect, the loading timings are decided by the loading timing setting section so as to avoid vehicle congestion when loading. Scheduling from material loading through to delivery enables vehicles to be more economically utilized.

In a fourth aspect of the present disclosure, in any one of the first aspect to the third aspect, the departure timing setting section is configured to set the departure timings by setting a travel route from the loading location to the usage location for each of the materials and by predicting a traffic volume of each of the travel routes.

In the material transportation support device according to the fourth aspect of the present disclosure, since the traffic volume is predicted, the computation accuracy of the transportation durations is improved compared to cases in which the departure timings are set based only on scheduled travel route distances.

A fifth aspect of the present disclosure is a material transportation method including: a process of acquiring usage timings for respective materials at a usage location of the materials; and a process of selling a departure timing from a loading location for each of the materials, based on material information including the usage timings and a distance from the loading location to the usage location for each of the materials, such that the materials arrive at the usage location in sequence starting from a material with an earliest usage timing.

In the material transportation method of the fifth aspect, the departure timings of each of the materials are set such that the materials will arrive at the usage location in sequence starting from the material with the earliest usage timing. This may enable the materials to he delivered to the usage location in the sequence in Which the materials are to be used.

As described above, the material transportation support device and the material transportation method of the present disclosure may enable efficient delivery of materials.

### BRIEF DESCRIPTION OF IRE DRAWINGS

An exemplary embodiment of the present disclosure will be described in detail based on the following figures, wherein:

FIG. 1 is a schematic diagram illustrating an overall configuration of a material transportation support system including a material transportation support device according to an exemplary embodiment;

FIG. 2 is a block diagram illustrating hardware configuration of a material transportation support device according to an exemplary embodiment;

FIG. 3 is a block diagram illustrating functional configuration of a material transportation support device according to an exemplary embodiment;

FIG. 4 is a flowchart illustrating an example of a flow of transportation support processing by a material transportation support device according to an exemplary embodiment; and

FIG. 5 is a table illustrating an example of departure timings and loading timings set by a material transportation support device according to an exemplary embodiment.

### DETAILED DESCRIPTION

Explanation follows regarding a material transportation support device 10 according to an exemplary embodiment, with reference to the drawings.

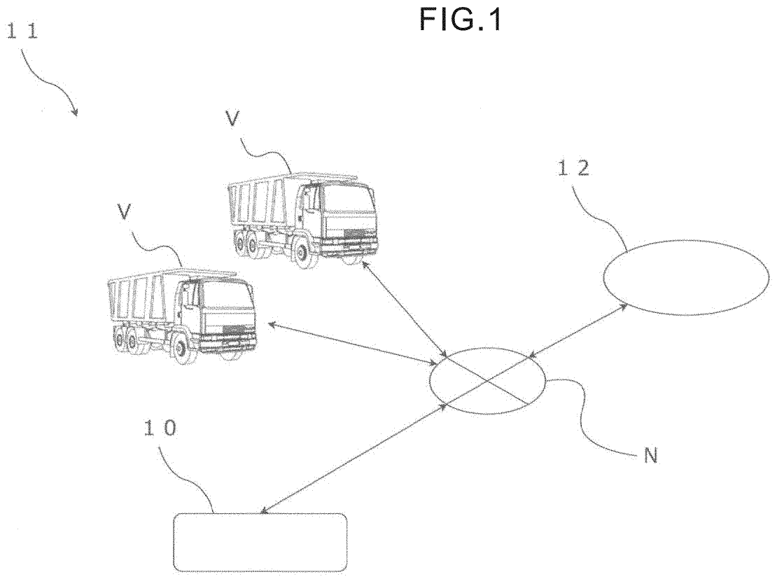

As illustrated in FIG. 1, a material transportation support system 11 of the present exemplary embodiment is configured including the material transportation support device 10, a server 12, and plural vehicles V. The material transportation support device 10, the server 12, and non-illustrated onboard units installed in the respective vehicles V are connected together over a network N.

Note that although only two vehicles V of the same size are illustrated as an example in FIG. 1, in reality plural vehicles V of different sizes, maximum load capacities, and so on are connected to the material transportation support device 10 over the network N.

Hardware Configuration of Material Transportation Support Device 10

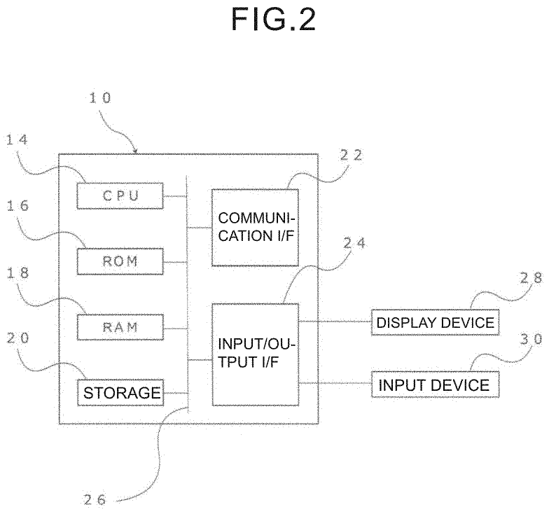

As illustrated in FIG. 2, the material transportation support device 10 of the present exemplary embodiment is configured including a central processing unit (CPU: a processor) 14, read only memory (ROM) 16, random access memory (RAM) 18, storage 20, a communication interface 22, and an input/output interface 24. The respective configurations are connected together so as to be capable of communicating through a bus 26. As an example, the material transportation support device 10 of the present exemplary embodiment is a terminal installed in a construction site, and is managed by a user such as a worker at the construction site.

The CPU 14 is a central processing unit that executes various programs and controls various sections. Namely, the CPU 14 reads a program from the ROM 16 or the storage 20, and executes the program using the RAM 18 as a workspace. The CPU 14 controls the respective configurations and performs various computation processing based on the programs recorded in the ROM 16 or the storage 20.

The ROM 16 holds various programs and various data. The RAM 18 acts as a workspace to temporarily store programs or data. The storage 20 is configured by a hard disk drive (HDD) or a solid state drive (SSD), and is a non-volatile recording medium that holds various programs including an operating system, and various data. In the present exemplary embodiment, a transportation support program and the like that sets departure timings of the respective vehicles V based on material information is held in the ROM 16 or the storage 20.

The communication interface 22 is an interface allowing the material transportation support device 10 to communicate over a computer network. A protocol such as 5G, LTE, Wi-Fi (registered trademark), or Ethernet (registered trademark) is employed therefor.

A display device 28 and an input device 30 are connected to the input/output interface 24. The display device 28 is a display or the like for outputting a computation result to the user. The input device 30 includes a keyboard, a mouse, or the like to allow the user to perform input to the material transportation support device 10.

Functional Configuration of Material Transportation Support Device 10

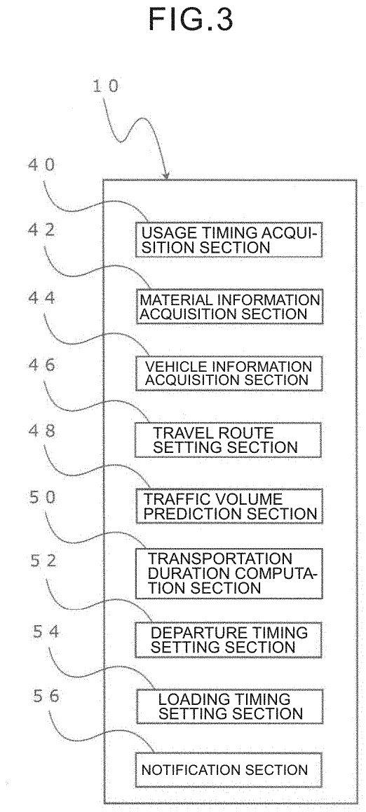

The material transportation support device 10 implements various functionality using the above-described hardware resources. Explanation follows regarding functional configuration implemented by the material transportation support device 10, with reference to FIG. 3.

As illustrated in FIG. 3, the material transportation support device 10 is configured including a usage timing acquisition section 40, a material information acquisition section 42, a vehicle information acquisition section 44, a travel route setting section 46, a traffic volume prediction section 48, a transportation duration computation section 50, a departure timing setting section 52, a loading timing setting section 54, and a notification section 56 as functional configuration. The respective functional configuration is implemented by the CPU 14 reading and executing a program stored in the ROM 16 or the storage 20.

The usage timing acquisition section 40 acquires information relating to usage timings of respective materials at the construction site, this being a usage location. For example, the usage timing acquisition section 40 may acquire a list of materials to be used at the construction site from building construction data held in the server 12, and information regarding timings when each material is required. Here, “materials” is a concept encompassing not only materials used to construct a building framework and so on, but also materials such as cement employed in building foundations and dirt used to raise the ground level. The concept also encompasses materials such as piping and fastenings employed in temporary scaffolding.

The material information acquisition section 42 acquires material information including a loading location for each material. In the present exemplary embodiment, information including the material type, material quantity, and material loading location (storage location) is set as the material information.

The vehicle information acquisition section 44 acquires vehicle information including the size of each of the material transportation vehicles V. In the present exemplary embodiment, information including the size, weight, and maximum load capacity of each vehicle V is set as the vehicle information. Note that the size of each vehicle V is a concept encompassing the vehicle height, vehicle width, and vehicle length. Acquiring the vehicle information thereby enables the expressway toll class to be ascertained for each of the material transportation vehicles V.

The travel route setting section 46 sets a travel route for each of the vehicles V based on the material information acquired by the material information acquisition section 42 and the vehicle information acquired by the vehicle information acquisition section 44. Specifically, when setting the travel route from the material loading location to the construction site, the travel route setting section 46 takes into consideration the vehicle information of the corresponding vehicle V so as to select only roads that the vehicle V is capable of traveling along. The travel route setting section 46 may also take into consideration the expressway toll class of the vehicle V when setting expressway entry and exit points. The travel route setting section 46 may also take into consideration the number of facilities and so on where the vehicle V is able to park on the travel route when setting the travel route.

The traffic volume prediction section 48 predicts a traffic volume on each vehicle V travel route set by the travel route setting section 46. The traffic volume prediction section 48 may for example acquire a traffic volume during a predetermined recent period, and predict what the traffic volume will be during transportation based on this traffic volume. The traffic volume prediction section 48 may also take into consideration major events taking place in the vicinity of the travel route when predicting the traffic volume.

The transportation duration computation section 50 computes the duration required for transportation from the loading location to the construction site for each vehicle V based on the travel route set by the travel route setting section 46 and the traffic volume information predicted by the traffic volume prediction section 48. Note that the computation of the transportation duration by the transportation duration computation section 50 may be performed by the processor configuring the material transportation support device 10, or may be calculated by a cloud-based server.

The departure timing setting section 52 sets a departure timing from the loading location for each material based on the material usage timing and the material loading location, such that the materials arrive at the construction site in sequence starting from the material with the earliest usage timing. Specifically, the departure timing setting section 52 takes into consideration the transportation durations computed by the transportation duration computation section 50 based on the information including the material usage timing and the loading location so as to set a departure timing for each material transportation vehicle V Namely, the transportation duration is calculated backward from the usage timing in order to set a departure timing for each vehicle V such that the material will be delivered to the construction site in time for the corresponding material usage timing. To avoid cases in which a material arrives before the delivery of another material to be used earlier, the departure timing setting section 52 may amend the departure timing to a later departure timing. Note that the departure timing refers to the departure timing of the vehicle V in a state in which loading has been completed. Moreover, departure timings may be set with predetermined margins such that materials will be delivered in time for the corresponding material usage timing, even should traffic congestion be encountered.

The loading timing setting section 54 sets a loading timing based on the departure timing set by the departure timing setting section 52. Specifically, the loading timing setting section 54 calculates the duration required for loading backward from the departure timing se by the departure timing setting section 52 in order to set the loading timing. The loading timing setting section 54 may compute a duration required for loading based on the information regarding the material size, weight, quantity, and so on as acquired by the material information acquisition section 42, and may add a margin to this computed loading duration when setting the loading timing.

The notification section 56 notifies the vehicles V of their departure timings as set by the departure timing setting section 52 and loading timings as set by the loading timing setting section 54. Specifically, the notification section 56 notifies the driver of each vehicle V through the onboard unit in the vehicle V by displaying the departure timing and the loading timing on the display or the like installed in the vehicle V. The notification section 56 also notifies of the travel route set by the travel route setting section 46. The notification section 56 may perform route setting using a navigation system installed in the vehicle V. In cases in which driver information is registered, the notification section 56 may notify a mobile terminal or the like carried by the driver of the vehicle V.

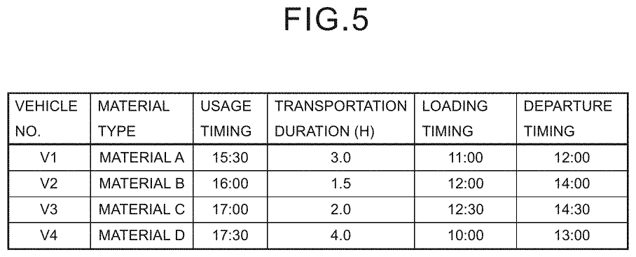

Explanation follows regarding an example of departure timing and loading timing setting using the above-described functionality, with reference to the table in FIG. 5.

Explanation follows regarding a case in which four materials, these being a material A, material B, material C, and material D, are to be transported, as illustrated in FIG. 5, The material A is to be transported by a No. 1 vehicle V1, and the material B is to be transported by a No. 2 vehicle V2. Similarly, the material C is to be transported by a No. 3 vehicle V3, and the material D is to be transported by a No. 4 vehicle V4.

Note that of these four materials, the usage timing of the material A is set to the earliest time, namely 15:30. The usage timing of the material B is set to 16:00, the usage timing of the material C is set to 17:00, and the usage timing of the material D is set to 17:30. Information regarding the usage timings of these material A to material D is acquired using the functionality of the usage timing acquisition section 40.

The transportation durations of the vehicle V1 to the vehicle V4 are respectively computed using the functionality of the transportation duration computation section 50. As previously described the transportation durations are computed based on the travel routes set by the travel route selling section 46 and the information regarding traffic volume predicted by the traffic volume prediction section 48. For example, the transportation duration for the vehicle V1 that transports the material A is three hours. This means that it will take three hours for the vehicle V1 loaded with the material A to travel from the loading location to the usage location, with rest breaks being included in this transportation duration.

The departure timings are set based on data regarding the usage timings of the material A to material D and the transportation durations of the vehicle V1 to the vehicle V4. The departure timings are set using the functionality of the departure timing setting section 52. The departure timing of the vehicle V1 that transports the material A is set to 12:00. The departure timing of the vehicle V2 that transports the material B is set to 14:00, the departure timing of the vehicle V3 that transports the material C is set to 14:30, and the departure timing of the vehicle V4 that transports the material D is set to 13:00.

The loading timings are set based on the departure timings using the functionality of the loading timing setting section 54. The loading timing of the material A is set to 11:00, this being one hour before the departure timing, and the loading timing of the material B is set to 12:00, this being two hours before the departure timing. The loading timing of the material C is set to 12:30, this being two hours before the departure timing, and the loading timing of the material D is set to 10:00, this being three hours before the departure timing. Namely, the loading timing setting section 54 of the present exemplary embodiment sets the loading timings in consideration of the duration required for loading. Specifically, the loading timing setting section 54 computes the durations required to load the respective materials based on the material information acquired by the material information acquisition section 42, and sets the loading timings in consideration of these durations. For example, since the material D requires more time for loading than the other materials A to C, the loading timing is set to three hours before the departure timing. The durations required for loading are computed based on the material information, including the material size, weight, and quantity.

Operation

Next, explanation follows regarding operation of the present exemplary embodiment.

Example of Transportation Support Processing

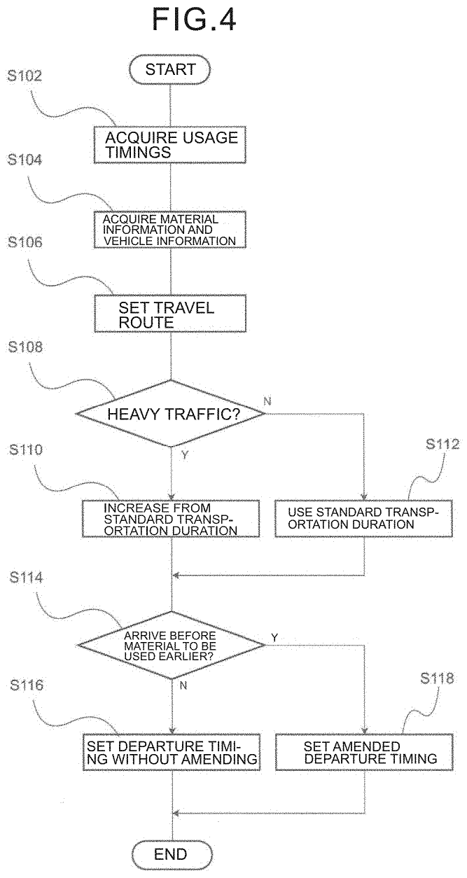

FIG. 4 is a flowchart illustrating an example of a flow of transportation support processing by the material transportation support device 10. The transportation support processing is executed by the CPU 14 reading a program from the ROM 16 or the storage 20 and expanding and executing the program in the RAM 18. As an example, a case is explained in which the material A to material D illustrated in the table in FIG. 5 are to be transported. Namely, the transportation support processing is performed in sequence for the vehicle V1 to the vehicle V4.

As illustrated in FIG. 4, at step S102, the CPU 14 acquires the usage timings. Specifically, the CPU 14 uses the functionality of the usage timing acquisition section 40 to acquire the respective usage timings of the material A to material D.

At step S104, the CPU 14 acquires the material information and the vehicle information. Specifically, the CPU 14 uses the functionality of the material information acquisition section 42 to acquire the material information regarding the material A to material D. The CPU 14 also uses the functionality of the vehicle information acquisition section 44 to acquire information regarding the vehicle V1 to the vehicle V4.

At step S106, the CPU 14 sets the travel routes. Specifically, the CPU 14 uses the functionality of the travel route setting section 46 to set the respective travel routes of the vehicle V1 to the vehicle V4. When this is performed, the CPU 14 selects roads that the vehicle V1 to the vehicle V4 are respectively capable of traveling along when setting the travel routes from the loading locations to the construction site. For example, in cases in which the vehicle V1 is a heavy vehicle, the travel route for the vehicle V1 is set so as to avoid roads that restrict the passage of heavy vehicles.

At step S108, the CPU 14 determines whether or not there is a heavy traffic volume. Specifically, the CPU 14 uses the functionality of the traffic volume prediction section 48 to predict the traffic volume for the travel routes set at step S106. In cases in which the predicted traffic volume predicted by the CPU 14 is heavy enough to affect the transportation durations, the CPU 14 determines that the traffic volume is heavy, and processing transitions to step S110. In cases in which the predicted traffic volume is not heavy enough to affect the transportation durations, the CPU 14 determines that the traffic volume is light, and processing transitions to step S112.

In cases in which the predicted traffic volume is heavy, at step S110 the CPU 14 computes transportation durations that are longer than standard transportation durations, and processing transitions to step S114. In cases in which the predicted traffic volume is light, at step S112 the CPU 14 computes the standard transportation durations, and processing transitions to step S114.

At step S114, the CPU 14 determines whether or not arrival will be before that of a material to be used earlier. For example, as illustrated in FIG. 5, the vehicle V2 transporting the material B has a set departure timing of 14:00 and a transportation duration of 1.5 hours, and so the expected arrival time is 15:30. Since the material A to be used before the material B has an expected arrival time of 15:00, the CPU 14 determines that the material B will not arrive earlier (i.e. will arrive later) than the material A, and processing transitions to step S116. On the other hand, supposing the expected arrival time of the material B were 14:30, the CPU 14 would determine that the material B will arrive earlier than the material A, and processing would transition to step S118.

At step S116, since the materials will arrive in sequence of their usage timings, the CPU 14 sets the departure timings without amending the departure timings. On the other hand, at step S118, since the arrival sequence of the materials is different from the usage timing sequence of the materials, the CPU 14 amends the departure timings. Specifically, the departure timings are amended such each material will arrive later than the arrival time of the material to be used earlier. The CPU 14 then ends the transportation support processing.

As described above, in the material transportation support device 10 according to the present exemplary embodiment, the usage timings of the respective materials at the material usage location is acquired by the usage timing acquisition section 40. This enables the sequence in which the respective materials are to be used at the usage location, for example a construction site, to be ascertained.

Moreover, the departure timing setting section 52 sets the departure timing from the loading location for each material based on the material information including the material loading location, and the material usage timing acquired by the usage timing acquisition section 40. When this is performed, the departure timing setting section 52 sets the departure timings such that the materials will arrive at the usage location in sequence starting from the material with the earliest usage timing. This enables the materials to be delivered to the usage location in the sequence in which the materials are to be used.

Furthermore, in the present exemplary embodiment, the transportation durations from the loading locations to the usage location are computed based on the material information and the vehicle information. This improves the computation accuracy of the transportation durations due to taking into consideration routes that may not be usable due to the size of the transporter vehicles.

Furthermore, the loading timings are decided by the loading timing setting section 54 so as to avoid vehicle congestion when loading. Scheduling from material loading through to delivery enables the vehicles to be more economically utilized.

Moreover, since the traffic volume is predicted by the traffic volume prediction section 48, the computation accuracy of the transportation durations is improved compared to cases in which the departure timings are set based only on scheduled travel route distances.

Although explanation has been given regarding the material transportation support device 10 according to the present exemplary embodiment, obviously various modifications may be implemented within a range not departing from the spirit of the present disclosure. For example, although a case has been described in which the four materials A to D are transported by the four vehicles V1 to V4 in the above exemplary embodiment, there is no limitation thereto. Namely, similar application may be made in cases in which five or more materials are to be transported. Note that there is no limitation to a configuration in which transportation support is performed for all the materials to be used, and a configuration may be applied in which departure timings are set only for certain materials.

Moreover, although a case has been described in which only one type of material is transported by a single vehicle V in the above exemplary embodiment, there is no limitation thereto. For example, application may also be made in cases in which plural types of materials are transported by a single vehicle V. In such cases, the departure timing may be set in consideration of the delivery timing of the material with the earliest usage timing out of the plural materials to be transported. In particular, if the site has a large temporary holding area for materials, the other materials may be temporarily held in this area.

Furthermore in the above exemplary embodiment, in cases in which a prediction is made partway through transportation of a material that the arrival will be earlier than was expected, an announcement may be made to prompt the driver of the vehicle to take a break. Namely, the travel route, break times, and so on may be adjusted so as to approach the computed transportation duration.

Furthermore, the processing executed by the CPU 14 reading and executing software (a program) in the above exemplary embodiment and modified examples may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The transportation support processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Although the storage 20 is a recording section in the above exemplary embodiment, there is no limitation thereto. For example, a recording section may be configured by a non-transitory recording medium such as compact disc (CD), digital versatile disc (DVD), or universal serial bus (USB) memory. In such cases, various programs may be held on such recording mediums.

What is claimed is:

1. A material transportation support, device comprising a processor, the processor being configured to:
acquire usage timings for respective materials at a usage location of the materials; and
set a departure timing from a loading location for each of the materials, based on the usage timings and material information including the loading location of the materials, such that the materials arrive at the usage location in sequence starting from a material with an earliest usage timing.

2. The material transportation support device of claim 1, wherein the processor is configured to set the departure timing based on a transportation duration computed from vehicle information including a size of a vehicle for transporting the materials, and based on the material information.

3. The material transportation support device of claim 1, wherein the processor is configured to set a loading timing based on the departure timing.

4. The material transportation support device of claim 1, wherein the processor is configured to set the departure timings by setting a travel route from the loading location to the usage location for each of the materials and by predicting a traffic volume of each of the travel routes.

5. The material transportation support device of claim 3, wherein the processor is configured to compute a duration required for loading from a size, a weight, and a quantity of the materials, and to set the loading timing based on this loading duration.

6. A material transportation method comprising, by a processor:
acquiring usage timings for respective materials at a usage location of the materials; and
setting a departure timing from a loading location for each of the materials, based on material information including the usage timings and a distance from the loading location to the usage location for each of the materials, such that the materials arrive at the usage location in sequence starting from a material with an earliest usage timing.
